(19) United States
(12) Patent Application Publication
(10) Pub. No.: US 2016/0288456 A1
(43) Pub. Date: Oct. 6, 2016

(54) METHOD FOR PRODUCING A MULTILAYER MOLDED BODY, AND MULTILAYER MOLDED BODY FOR THE HEAT INSULATION OF BUILDINGS

(71) Applicant: STO SE & CO. KGAA, Stühlingen (DE)

(72) Inventors: Martin HITZLER, Gottmadingen (DE); Andreas WEIER, Trossingen (DE); Gerald BURGETH, Lauchringen (DE); Joachim EGGI, Stühlingen (DE); Peter ENGELNIEDERHAMMER, Wittislingen (DE); Jochen KOHNLEIN, Mottingen (DE); Frithjof KOERDT, Berlin (DE); Martin BAUER, Tauberbischofsheim (DE)

(21) Appl. No.: 15/036,341

(22) PCT Filed: Nov. 10, 2014
(86) PCT No.: PCT/EP2014/074152

§ 371 Date: May 12, 2016

(30) Foreign Application Priority Data
Nov. 13, 2013 (EP) 13192680.0

(51) Int. Cl. B32B 5/20; E04B 1/94; E04B 1/76; B32B 7/12; B32B 5/32

(52) U.S. Cl. CPC B32B 5/20; B32B 7/12; B32B 5/32; E04B 1/76; E04B 1/941; B32B 2264/0235; B32B 2264/0257; B32B 2307/304; B32B 2307/4026

(57) ABSTRACT

A method for producing a multilayer molded body for the heat insulation of buildings, for which foamable or pre-foamed polymer particles for forming a layer are used. The foamable or pre-foamed polymer particles are at least partially coated with an organic binding agent, and are bonded in a mold having at least one plate made of expanded or extruded polystyrene rigid foam for carrying out a final foaming process. The invention furthermore relates to a multilayer molded body for the heat insulation of buildings.

### CROSS REFERENCE TO RELATED APPLICATIONS

This is a U.S. national stage of application No. PCT/EP2014/074152, filed on Nov. 10, 2014. Priority under 35 U.S.C.§119(a) and 35 U.S.C.§365(b) is claimed from European Patent Application No. 13192680.0 filed on Nov. 13, 2013, the disclosure of which is also incorporated herein by reference

The invention relates to a method for producing a multilayer molded body for the heat insulation of buildings comprising the features of the preamble of claim 1. The invention further relates to a multilayer molded body for the heat insulation of buildings.

### BACKGROUND

Multilayer molded bodies for the heat insulation of buildings comprising at least one layer of an expanded or extruded polystyrene rigid foam are already known from the prior art. The bonding of the layer consisting of polystyrene rigid foam to at least one further layer can have different advantages, depending on the correct embodiment and/or arrangement of the further layer.

On principle, an outer layer of such a multilayer molded body for the heat insulation of buildings has an additional protective function. Even though it is also possible to cover a homogeneously embodied molded body after the installation thereof for the purpose of heat insulation in order to realize an additional, possibly only temporary protective function, for example by means of a sheathing or a hanging, this requires additional operating steps and is accordingly time and cost-intensive.

A two-layer insulation plate for thermally insulating housing facades, in the case of which both layers consist of expanded polystyrene granulate, which includes athermanous substances for increasing the thermal insulating effect, is thus already known from EP 2 557 247 A1. Light color pigments are furthermore added to the second layer for brightening purposes, so that impinging heat rays are reflected by the second layer so as to keep the two-layer insulation plate free from stress. The insulation plate is thus preferably attached to a building facade with the second layer being located on the outside.

The production of the insulation plate of EP 2 557 247 A1 takes place in a heatable mold, wherein a first expanded polystyrene granulate is added to the mold for the formation of the first layer, and a second expanded polystyrene granulate is added for the formation of the second layer, and are subsequently fused to form an integral heat insulation plate.

A multilayer heat insulation plate furthermore follows from DE 20 2009 009 986 U1. A first and a second layer of expandable polystyrene are thereby bonded in such a manner that elevations of the one layer engage with depressions of the other layer in the contact region of the two layers. To obtain this, the second layer is foamed onto the first layer, or vice versa. The foaming can thereby also be made onto a layer, which is produced as pre-product.

The thermal bonding of the plurality of layers in one operating step with the production thereof is thus favored in the prior art. In addition, however, it is also possible to produce the plurality of layers separately and to bond them subsequently.

In addition, heat insulation plates, which simultaneously have a drainage function, are known from the prior art. Such insulation plates are mainly used for the heat insulation of outer walls of a building, which are located underground. Their task is to keep moisture away from the building. To achieve this, such heat insulation plates often have a relief-like design on their surface, which is to face the building, so that cavities are created between the outer wall and the insulation plate, via which the moisture can be removed.

A heat insulation plate, which can be used as drainage plate, follows in an exemplary manner from DE 10 2004 033 535 A1. To realize the drainage function, the plate has a profiling at least on one side. The profiling can comprise grooves or depressions, for example, which are incorporated in the surface of the plate. They serve as discharge channels, so that the drainage function can be realized by means thereof If the plate is only profiled on one side, the profiled surface preferably comes to rest against the outer wall of the building, which is to be insulated. The surface facing away from the outer building wall can be provided with a woven filter medium to prevent the sluicing of soil. This heat insulation plate can also be embodied in multiple layers in this regard, wherein the woven filter medium, in turn, fulfills a protective function as further layer.

### OBJECT AND SUMMARY OF THE INVENTION

Based on the above-mentioned prior art, the present invention is based on the object of specifying a method for producing a multilayer molded body for the heat insulation of buildings, which can be carried out in a simple and cost-efficient way. The method is to in particular provide for the production of a multilayer molded body, which comprises at least one layer of expanded and/or extruded polystyrene rigid foam. In addition to a heat-insulating effect, the molded body produced according to this method is to also have a drainage function and is to thus be capable of being used as drainage plate as well. In addition, a multilayer molded body for the heat insulation of buildings, which is also able to fulfill a drainage function, is to be provided.

To solve the object, the method comprising the features of claim 1 is specified. Advantageous further developments of the invention can be gathered from the subclaims. In addition, a multilayer molded body is proposed, which can be used as insulation and drainage plate. The proposed molded body can in particular be produced according to the method according to the invention.

### DISCLOSURE OF THE INVENTION

In the case of the method proposed for producing a multilayer molded body, foamable or pre-foamed polymer particles are used to form a layer. According to the invention, the foamable or pre-foamed polymer particles are at least partially coated with an organic binding agent and are bonded in a mold having at least one plate made of expanded or extruded polystyrene rigid foam for carrying out a final foaming process.

The coating of the pre-foamed polymer particles with an organic binding agent fulfills a plurality of functions.

On the one hand, the coating influences the expansion behavior of the polymer particles during the final foaming process in such a way that the expansion, that is, the volume increase, of the individual particles is reduced. This is so, because the coating acts like a corset, which counteracts the expansion. As a result, an interstitial volume, which forms a cohesive, water-permeable cavity volume, remains between the individual particles after the final foaming process.

On the other hand, the binding agent promotes a stable bond of the polymer particles among one another, because the binding agent simultaneously serves as adhesive. This is in particular advantageous, because—as already mentioned above—the polymer particles experience a slight expansion during the final foaming process and because the contact region of the particles among one another is thus limited to individual contact points. Accordingly, an extensive fusion of the particles does not take place. The binding agent, however, is able to attain a stable bond of the particles among one another in the contact region by forming a film, so that the slight level of the fusion is compensated thereby.

The at least one plate made of expanded or extruded polystyrene rigid foam also fulfills a plurality of functions.

On the one hand, the plate simplifies the production process, when it is positioned or inserted into the mold, for example prior to the introduction of the polymer particles. The plate then forms a separating layer, which facilitates the demolding of the molded body. This is so, because the plate prevents the particles, which are coated with an organic binding agent, from coming into contact with the mold, adhere thereto and lead to nicks on the surface of the molded body in response to demolding.

On the other hand, the plate made of expanded or extruded polystyrene rigid foam itself has a largely smooth surface, which is particularly well suited for accommodating a plaster or mortar layer. A plaster or mortar application of consistent thickness is also ensured across the smooth surface, because a plaster or mortar mass cannot deposit in surface depressions of the plate.

The plate made of expanded or extruded polystyrene rigid foam thus preferably forms a cover layer. A common EPS or XPS plate can be used as plate. Preferably, a recycling plate is used so as to conserve resources and/or so as to reduce costs.

The plate made of expanded or extruded polystyrene rigid foam furthermore has a reinforcing function and thus contributes to the mechanical stability of a multilayer molded body produced according to the method according to the invention. This applies in particular when the layer, which has the cohesive cavity volume, is covered by a plate made of expanded or extruded polystyrene rigid foam on both sides.

Due to the fact that the plate made of expanded or extruded polystyrene rigid foam is already finally foamed, that is “dead” material, it is not possible to effect a stable bond of the plate to the polymer particles, which are to still be finally foamed, solely via a fusion. Due to the fact that, in the case of the proposed method, the polymer particles, which are to still be finally foamed, are first coated with an organic binding agent, a stable bond between the particles and the plate can be effected via the organic binding agent in the case at hand. Accordingly, this can be seen as a further function of the organic binding agent.

Preferably, 0.5-75% by weight, preferably 1-50% by weight, more preferably 1.5-25% by weight of at least one an organic binding agent, based on the total weight of the foamable or pre-foamed polymer particles, are used to coat the foamable or pre-foamed polymer particles. It follows from this that the percent by volume of the binding agent is relatively small. On the one hand, the small percent by volume of the binding agent has the effect that the excellent heat insulation characteristics of the polymer foam are substantially maintained. On the other hand, it has the effect that the interstitial volume between the polymer particles remains largely free from binding agent and forms a cohesive, water-permeable cavity volume in this manner. The binding agent portion, however, is chosen to be sufficiently high so as to obtain a stable bond of the particles among one another as well as with the at least one plate. The binding agent portion can be reduced to a minimum in that an organic binding agent is used additionally, which has an increased bonding strength as compared to a mineral binding agent, for example.

When carrying out the method according to the invention, polymer particles of polystyrene (EPS), polyethylene (EPE), polypropylene (EPP) and/or polylactide (PLA) are used in a preferably manner. Particularly preferably, polystyrene particles are used, because they can be produced or obtained, respectively, in a cost-efficient manner.

More preferably, a thermosetting binding agent, for example epoxy resin and/or polyurethane, and/or a thermoplastic binding agent, for example homo-, co- or terpolymers of acrylate, styrene acrylate, vinyl acetate, ethylene, vinyl versatate, vinyl laurate, alkyl acrylate and/or vinyl chloride, as organic binding agent is used to coat the foamable or pre-foamed polymer particles. Such binding agents have a high bonding strength, so that the portion thereof, based on the polymer particles, which are to be coated, can be kept small. After the hardening or drying, respectively, they form a film, which completely or at least partially covers the particles and which ensures a stable bond of the particles among one another in the respective contact regions.

In addition to an individual binding agent, it is also possible to use binding agent mixtures comprising at least two different organic binding agents and/or binding agents of polymer mixtures of hetero polymers. To obtain an optimum adhesion of the polymer particles among one another and/or with the plate made of expanded or extruded polystyrene rigid foam, it is preferable to use an organic binding agent or an organic binding agent mixture, respectively, which has a glass transition temperature below the softening temperature of the foamable or pre-foamed polymer particles.

It is furthermore proposed to use an organic binding agent in the formulation as water-based or water-free dispersion, as powder or as dispersion powder. When using a water-based or water-free dispersion binding agent, an even coating of the polymer particles is ensured in a simple way. When using a powdery organic binding agent, an even coating can be obtained by mixing the precursors.

The use of a binding agent in powder form has the advantage that the binding agent is first activated by adding moisture and/or heat. The coating takes place by bringing the powdery organic binding agent into contact with the foamable or pre-foamed polystyrene particles. As a result of the surface roughness of the particles, an adhesion of the powdery binding agent to the particles is obtained by bringing the particles into contact with one another. In addition, moisture can be added as a result of the contacting, in that the polystyrene particles are moistened slightly prior to being brought into contact with the powdery binding agent, for example. Preferably, the contacting occurs by mixing the precursors, so as to ensure an even distribution of the binding agent.

If foamable polystyrene particles, so-called polystyrene beads, are used, the coating with the binding agent can occur during a pre-foaming process. For this purpose, the polystyrene beads and the binding agent powder are placed into a pre-foaming container, which is preferably designed as stirrer or mixer at the same time. The movement in the pre-foaming container then contributes to an even distribution of the binding agent. If water vapor is used as heating medium in response to the pre-foaming—as is the case routinely—this leads to a softening of the binding agent. Supported by the movement of the polystyrene particles in the pre-foaming container, the softened binding agent sheathes the particles, so that they are at least partially covered by the binding agent.

The foamable or pre-foamed polymer particles, which are at least partially coated with an organic binding agent, are furthermore preferably placed into the mold prior to the complete drying of the binding agent, and are pre-foamed or finally foamed. This ensures that the binding agent unfolds its full binding effect and that the formation of a cohesive film occurs in the contact region of the polymer particles among one another as well as in the contact region of the polymer particles comprising the plate made of expanded or extruded polystyrene rigid foam.

As a further development of the invention it is proposed for foamable or pre-foamed polymer particles to be added to the coated foamable or pre-foamed polymer particles prior to the introduction into the mold. The size of the cohesive cavity volume and thus the water-permeability of the layer, which has the cohesive cavity volume, can be controlled by adding uncoated foamable or pre-foamed polymer particles. This is so, because, in contrast to the coated foamable or pre-foamed polymer particles, the uncoated foamable or pre-foamed polymer particles can expand to a largely unhindered extent, whereby the interstitial volume between the particles is reduced. At the same time, the added uncoated foamable or pre-foamed polymer particles support a fusion of the particles among one another or a fusion of the particles with the plate made of expanded or extruded polystyrene rigid foam, which has a positive effect on the mechanical stability of the mold body, which is to be produced.

The portion of the uncoated foamable or pre-foamed polymer particles is preferably less than 50% by volume, more preferably less than 30% by volume and particularly preferably less than 15% by volume, based on the total volume of the coated and uncoated polymer particles. This means that the portion of uncoated particles is less than the portion of coated particles in any event, so as not to nullify the advantages mentioned above in connection with the coated particles.

It can furthermore prove to be advantageous to add fibers, fillers, pigments and/or additives, such as, for example, thickening agents, wetting agents, stabilizers, defoamers, flame retardants or rheology additives to the foamable or pre-foamed polymer particles prior to or after the coating with the organic binding agent. In particular the processing characteristics can be influenced by means of the additives, while the fibers, fillers and/or pigments mainly impact the characteristics of the subsequent molded body.

If the molded body, which is to be produced, is to be equipped with a flame retardant, expandable graphite is preferably added as flame retardant.

According to a preferred embodiment of the invention, all precursors are mixed homogenously to form the layer, which forms the hollow cavity structure, and are subsequently bonded in a mold having plates of expanded or extruded polystyrene rigid form for the purpose of carrying out a final foaming process in such a manner that the layer, which forms the hollow cavity structure, comes to rest between the plates. The plates thus form exterior cover layers, which improve the reinforcement of the multilayer molded body, which is produced in this manner. While still in the mold, the plates serve as separating layers, which facilitate the demolding of the molded body.

In the case of the molded body, which is produced according to the method according to the invention, the layer, which has the cohesive cavity volume and which is covered by a layer of expanded or extruded polystyrene rigid foam on one side or on both sides, forms the actual drainage layer. This is so, because this layer is water-permeable as a result of the cohesive cavity volume. Due to the fact that a common EPS or XPS plate does not have a cohesive cavity volume, said plate is not water-permeable.

If the water-permeable layer is only covered on one side by a water-impermeable layer of expanded or extruded polystyrene rigid foam, the molded body is preferably attached to an outer wall of a building in such a manner that the water-impermeable layer comes to rest on the outside and the water-permeable layer comes to rest directly on the outer wall. The accumulating moisture between the outer wall and the molded body can then be discharged via the water-permeable layer.

However, the multilayer molded body produced according to a method according to the invention can also be attached to an outer wall in such a way that a water-impermeable layer of expanded or extruded polystyrene rigid foam comes to rest directly on the outer wall. In this case, it proves to be advantageous, if at least one plate made of expanded or extruded polystyrene rigid foam is used, which has channels, which extend from one surface of the plate to the other surface. The channels can have been or can be introduced into the plate by means of punching, drilling and/or milling, for example. The channels, which extend through the plate, form drainage channels, which make the plate water-permeable, so that a connection of the space between the molded body and the outer wall to the cohesive cavity volume of the adjacent layer can be established via the channels. Moisture, which reaches into the space between the molded body and the outer wall, can be removed in this manner and the outer wall is kept dry.

The method according to the invention is advantageously carried out in a molding machine, which makes it possible for water vapor to flow through the mold on all sides. The all-sided flow-through accelerates the defoaming process of the foamable or pre-foamed polymer particles, even if the layer formed therefrom is not only covered on one side by a plate made of expanded or extruded polystyrene rigid foam. In the alternative or in addition, the use of a molding machine is proposed, which does not only make it possible to apply an excess pressure, but also the application of a low pressure.

Furthermore, a multilayer molded body comprising at least one layer of expanded and/or extruded polystyrene rigid foam is proposed to solve the above-mentioned object. According to the invention, said molded body is characterized in that the layer of expanded or extruded polystyrene rigid foam is bonded to a further layer, which comprises foamed polymer particles, which are bonded via an organic binding agent, as well as an interstitial volume, which remains between the polymer particles and which forms a cohesive cavity volume. As a result of the cohesive cavity volume, the further layer is water-permeable. This means that the further layer is able to discharge moisture. Accordingly, the proposed multiplayer molded body is not only suitable for the heat insulation of buildings, but can further be used as drainage plate.

The polymer particles of the further layer are at least partially bonded via the organic binding agent contained therein. In addition, the polymer particles can be fused to one another, wherein no fusion or only a partial fusion can be found in regions, in which there is a bonding via the binding agent.

The polymer particles of the further layer are thus at least partially enclosed by a binding agent film, which effects the bonding of the particles among one another.

The proposed multilayer molded body is preferably produced according to the above-described method according to the invention. The use of the method according to the invention ensures the formation of a cohesive cavity volume via the remaining interstitial volume. The use of the method according to the invention furthermore ensures that the multilayer molded body, which is produced in this manner, has a sufficient mechanical stability. This is so, because a stable bond of the polymer particles among one another is effected via the cohesive force of the organic binding agent.

Preferably, the layer of expanded or extruded polystyrene rigid foam is also bonded to the further layer via the organic binding agent, which is contained in the further layer. This applies in particular when the method according to the invention is used. This is so, because in the case of the method according to the invention, “dead” material in the form of an EPS or XPS plate, which is placed or inserted, respectively, into the mold prior to filling in the polymer particles, is used to form the layer of expanded or extruded polystyrene rigid foam. Due to the fact that the use of “dead” material makes it more difficult to fuse the polymer particles to the EPS or XPS plate, the bonding of the layers is preferably effected via the organic binding agent.

To ensure a sufficient mechanical stability of the multilayer molded body on the one hand and to keep the interstitial volume between the polymer particles as free from binding agent as possible on the other hand, it is proposed for the binding agent portion in the further layer to be 0.5-75% by weight, preferably 1-50% by weight, more preferably 1.5-25% by weight, based on the total weight of the polymer particles of the further layer.

In an advantageous embodiment of the invention, the further layer has a layer thickness of 10-500 mm and/or a molded density of 15-60 kg/m³. The cycle times increase with the thickness of the further layer, because a larger quantity of foamable or pre-foamed polymer particles needs to be finally foamed. This is why a thinner layer proves to be advantageous. The layer thickness, however, needs to be dimensioned sufficiently so as to ensure the drainage function.

In the alternative or in addition, it is proposed for the layer of expanded or extruded polystyrene rigid foam, which is bonded to the further layer, to have a layer thickness of 0.1-50 mm and/or a molded density of 10-40 kg/m³. In the function as cover layer, the thickness of the layer of expanded or extruded polystyrene rigid foam, which is bonded to the further layer, can be kept so as to be smaller than the thickness of the further layer. However, the opposite can also be the case, so as to increase the cycle times in response to the production of the molded body, for example.

Preferably, channels, which extend so as to run straight or diagonally through the entire layer, are preferably formed in the layer of expanded or extruded polystyrene rigid foam. The channels serve as drainage channels.

In the use as drainage plate, the multilayer molded body is preferably installed in such a way that the layer, which has the channels, faces the outer wall, which is to be insulated. Moisture, which reaches between the outer wall and the molded body, can be discharged to the outside via the channels. The moisture thereby hits the water-permeable further layer, via which the moisture is removed completely.

If the channels are embodied so as to run diagonally, the molded body is preferably installed such that the channels run downwards, away from the outer wall. The diagonal course provides a drainage direction, which additionally promotes the removal of moisture. A straight course of the channels through the cover layer has the advantage that the installation position of the molded body is arbitrary.

If the water-permeable layer is in each case covered by a layer of expanded or extruded polystyrene rigid foam comprising channels, which run diagonally, on both sides, the channels are preferably embodied in a mirror-symmetrical manner. This means that the channels are embodied so as to be inclined in opposite direction.

More preferably, the channels are arranged at regular intervals and have an angled or round cross section. For example, the cross section can be embodied in a slit-shaped manner.

Due to its advantages, the proposed multilayer molded body is preferably used as heat insulation and drainage plate. In this use, the advantages of the multilayer molded body according to the invention have a particularly positive effect. Further areas of use are possible, for example in the area of interior insulation.

The method according to the invention will be explained in more detail below by means of a preferred exemplary embodiment.

### Exemplary Embodiment

85% by weight of EPS-Beads are mixed with 15% by weight of dispersion powder (base terpolymer of ethylene, vinyl laurate, and vinyl chloride) and are pre-foamed by adding pressure (1 bar) and heat (100° C.), wherein water vapor serves as heating medium. The dispersion powder escapes thereby and forms a polymer film on the pre-foamed EPS beads. The coated and pre-foamed EPS beads are subsequently dried for a short time in a fluidized bed drier.

A common EPS plate (white) with a thickness of 1 cm with the dimensions 80 cm×120 cm is inserted into a mold with the same dimensions of a molding machine. The height of the mold is 12 cm. The mold is subsequently filled completely with the previously coated pre-foamed EPS beads.

The mold content is then finally foamed into a multiplayer plate comprising a thickness of 12 cm, in that water vapor is introduced and a low pressure is applied. In response to the final foaming, the pre-foamed coated EPS particles compress into a layer, which forms a cohesive cavity volume and which is simultaneously mechanically stable, because the bond is simultaneously attained via the adhesive or cohesive force, respective, of the bonding agent. The cohesive force of the bonding agent further ensures a stable bond of the layers among one another. This is so, because a fusion of the layers is only attained to a small degree by using a common EPS plate, because the polystyrene particles contained in the plate are already finally foamed.

In the case at hand, the final foaming of the plurality of layers for the production of the multilayer molded body preferably occurs by adding heat, namely at a temperature of between 80° C. and 120° C. This can lead to the softening of the “dead” material, so that at least a partial fusion of the layers is effected.

The multilayer molded body according to the invention will be explained in more detail below by means of the figures.

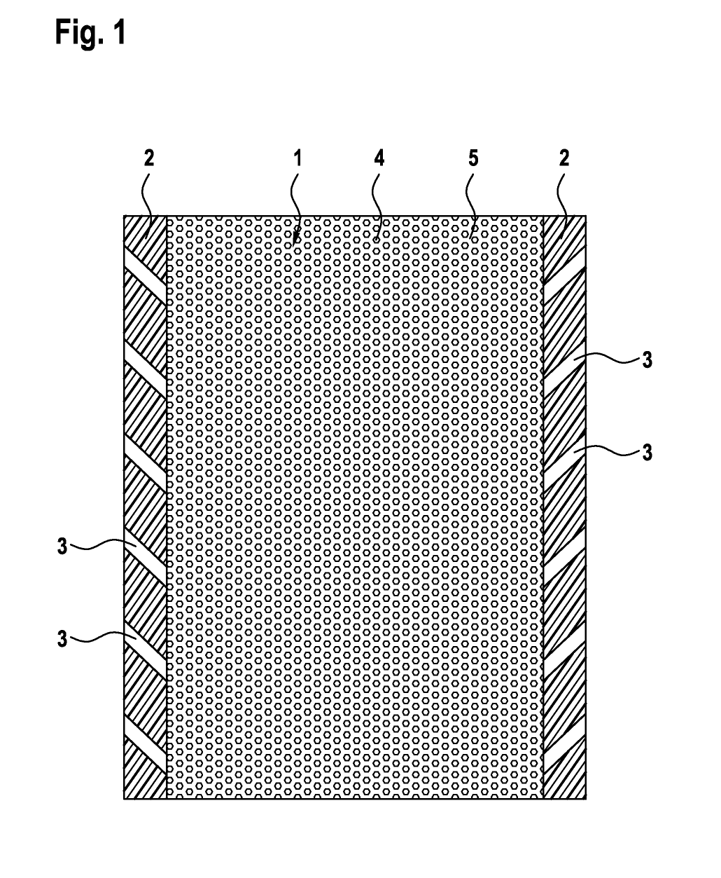

FIG. 1 shows a cross section through a multilayer molded body according to the invention according to a preferred embodiment,

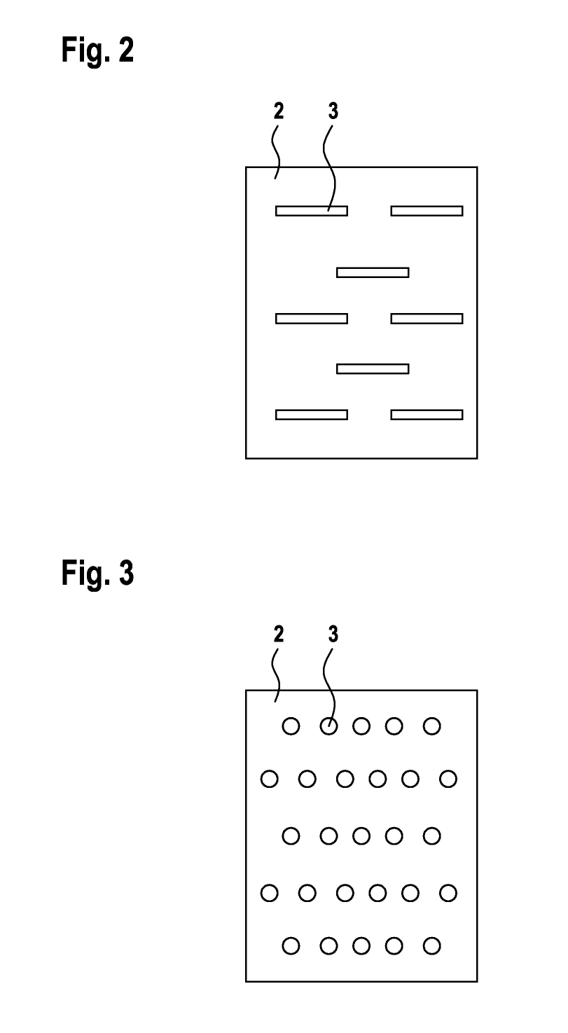

FIG. 2 shows a top view onto the molded body of FIG. 1 and

FIG. 3 shows a top view onto a molded body according to an alternative preferred embodiment.

### DETAILED DESCRIPTION OF THE FIGURES

The multilayer molded body illustrated in FIG. 1 as a whole comprises three layers, namely a water-permeable interior layer 1, which is surrounded by layers 2, which form cover layers, on both sides. The water-permeable interior layer 1 is mainly formed of expanded polystyrene particles 4, which are bonded via a film, which covers the particles, of an organic binding agent. The interstitial volume, which remains between the particles 4, forms a cohesive cavity volume 5, which has the result that the layer 1 is water-permeable. The layer 1 is thus able to fulfill a drainage function.

The exterior layers 2 in each case consist of common expanded polystyrene rigid foam and form water-impermeable layers, because they do not have a cohesive cavity volume. In order to supply moisture to the interior layer 1 from the outside, however, the cover layers 2 have channels 3, which extend so as to run diagonally downwards from outside through the layer 2 all the way to the interior layer 1. The channels 3 direct the moisture from the outside in the direction of the interior layer 1. In the case at hand, this is additionally supported in that the course of the channels 3 is chosen to be diagonal.

As can be gathered from FIGS. 2 and 3, the number, configuration and size of the channels 3 can be chosen so as to meet the requirements. The cross sectional shape can also be chosen freely and can be slit-shaped (FIG. 2) or circular (FIG. 3), for example.

1. A method for producing a multilayer molded body for the heat insulation of buildings, for which foamable or pre-foamed polymer particles for forming a layer are used, characterized in that the foamable or pre-foamed polymer particles are at least partially coated with an organic binding agent, and are bonded in a mold having at least one plate made of expanded or extruded polystyrene rigid foam for carrying out a final foaming process.

2. The method according to claim 1, characterized in that 0.5-75% by weight, preferably 1-50% by weight, more preferably 1.5-25% by weight of at least one an organic binding agent, based on the total weight of the foamable or pre-foamed polymer particles, are used to coat the foamable or pre-foamed polymer particles.

3. The method according to claim 1, characterized in that polymer particles of polystyrene, polyethylene, polypropylene and/or polylactide are used.

4. The method according to claim 1, characterized in that a thermosetting binding agent, for example epoxy resin or polyurethane, and/or a thermoplastic binding agent, for example homo-, co- or terpolymers of acrylate, styrene acrylate, vinyl acetate, ethylene, vinyl versatate, vinyl laurate, alkyl acrylate and/or vinyl chloride is used as organic binding agent.

5. The method according to claim 1, characterized in that an organic binding agent in the formulation as water-based or water-free dispersion, as powder or as dispersion powder is used to coat the foamable or pre-foamed polymer particles.

6. The method according to claim 1, characterized in that the foamable or pre-foamed polymer particles, which are at least partially coated with an organic binding agent, are placed into the mold prior to the complete drying of the binding agent, and are pre-foamed or finally foamed.

7. The method according to claim 1, characterized in that uncoated foamable or pre-foamed polymer particles are added to the coated foamable or pre-foamed polymer particles prior to the introduction into the mold, wherein the portion of the uncoated foamable or pre-foamed polymer particles is preferably less than 50% by volume, more preferably less than 30% by volume, and particularly preferably less than 15% by volume, based on the total volume of the coated and uncoated foamable or pre-foamed polymer particles.

8. The method according to claim 1, characterized in that fibers, fillers, pigments and/or additives, such as, for example, thickening agents, wetting agents, stabilizers, defoamers, flame retardants or rheology additives are added to the foamable or pre-foamed polymer particles prior to or after the coating with the organic binding agent.

9. The method according to claim 1, characterized in that expandable graphite is added as flame retardant.

10. The method according to claim 1, characterized in that at least one plate made of expanded or extruded polystyrene rigid foam is used, which has channels, which extend from one surface of the plate to the other surface.

11. A multilayer molded body for the heat insulation of buildings, comprising at least one layer of expanded and/or extruded polystyrene rigid foam, characterized in that the layer of expanded or extruded polystyrene rigid foam is bonded to a further layer, which comprises foamed polymer particles, which are bonded via an organic binding agent, as well as an interstitial volume, which remains between the polymer particles and which forms a cohesive cavity volume.

12. The molded body according to claim 11, characterized in that the layer of expanded or extruded polystyrene rigid foam is bonded to the further layer via the organic binding agent, which is contained in the further layer.

13. The molded body according to claim 11,
characterized in that the portion of the organic binding agent in the further layer is 0.5-75% by weight, preferably 1-50% by weight, more preferably 1.5-25% by weight, based on the total weight of the polymer particles of the further layer.

14. The molded body according to claim 11, characterized in that the further layer has a layer thickness of 10-500 mm and/or a molded density of 15-60 kg/m³.

15. The molded body according to claim 11, characterized in that the layer of expanded or extruded polystyrene rigid foam, which is bonded to the further layer, has a layer thickness of 0.1-50 mm and/or a molded density of 10-40 kg/m³.

16. The molded body according to claim 11, characterized in that channels, which extend so as to run straight or diagonally through the entire layer, are formed in the layer of expanded or extruded polystyrene rigid foam.

17. The molded body according to claim 16, characterized in that the channels are arranged at regular intervals and have an angled or round cross section.

18. A use of a molded body according to claim 11 as heat insulation and drainage plate.
